(19) United States
(12) Patent Application Publication
(10) Pub. No.: US 2008/0148829 A1
(43) Pub. Date: Jun. 26, 2008

(54) Method and device for operating a drive unit

(76) Inventor: Carl Bohman, Stuttgart (DE)

Correspondence Address: KENYON & KENYON LLP, ONE BROADWAY, NEW YORK, NY, 10004, US

(21) Appl. No.: 11/999,844

(22) Filed: Dec. 6, 2007

(30) Foreign Application Priority Data
Dec. 6, 2006 (DE) 102006057801.5

(51) Int. Cl. G01M 15/02

(52) U.S. Cl. 73/114.68

(57) ABSTRACT

A method and a device for operating a drive unit, which make possible a diagnosis of a function of a coolant pump in a coolant circulation of an engine in an after-running of the drive unit, independently of various external and internal conditions of the drive unit. A malfunction of the coolant pump is detected, in this instance, as a function of a variable characterizing the battery voltage of the drive unit and/or as a function of a variable characterizing a curve over time of a variable influenced by the operation of the coolant pump in the after-running of the drive unit.

### BACKGROUND INFORMATION

Methods and devices are known which diagnose a function of a coolant pump in a coolant circulation of the drive unit during after-running of the drive unit.

### SUMMARY OF THE INVENTION

The method according to the present invention and the device according to the present invention have the advantage that a malfunction of the coolant pump is detected during after-running of the drive unit, as a function of a variable characterizing the battery voltage of the drive unit and/or as a function of a variable characterizing a curve over time of a variable that is influenced by the operation of the coolant pump. In this way, the diagnosis of the function of the coolant pump is independent of various external and internal conditions of the operation of the drive unit, such as the driving cycle, the ambient temperature, the parking area of the drive unit and the configuration of a fan for a radiator in the coolant circulation of the drive unit.

It is particularly advantageous if a variable characterizing the engine temperature of the drive unit is selected as the variable influenced by the operation of the coolant pump. Such a variable is extremely simple to ascertain and using a sensor system that is already installed, for instance, in the form of the engine temperature itself, so that no additional expenditure is required for the diagnosis. In addition, this variable is in a direct connection with the cooling performance, and thus with the functioning of the coolant pump, and is therefore especially suitable and meaningful for diagnosing a malfunction of the coolant pump.

A further advantage comes about if, as the variable characterizing the curve over time of the variable of the drive unit influenced by the operation of the coolant pump, one selects the second derivative of the variable of the drive unit influenced by the operation of the coolant pump. In this way it is particularly simple and economical, as well as especially meaningful and reliable, to ascertain the curve over time for the diagnosis of a malfunction of the coolant pump.

However, one is also able to make the diagnosis in an especially simple manner by comparing the second derivative with respect to time of the engine temperature, during after-running of the drive unit, to a predefined threshold value, and to detect a malfunction of the coolant pump if the second derivative with respect to time exceeds the predefined threshold value.

In order to compensate for the independence of the diagnosis from the ambient temperature, it may advantageously be provided that one should specify the threshold value as a function of the ambient temperature of the drive unit.

In order to compensate for the independence of the diagnosis from the operation of a fan for dissipating the heat from the cooling element of the coolant circulation, it may advantageously be provided that one should specify the threshold value as a function of the operation of the fan.

Since the cooling performance is greater in response to an activated fan than an inactive fan, in order to obtain a reliable diagnosis, in an advantageous manner the specified threshold value may be selected to be smaller in the case of an activated fan than of an inactive fan.

In order to avoid a faulty diagnosis, it may also be advantageously provided that one should detect a malfunction of the coolant pump only if the variable of the drive unit influenced by the operation of the coolant pump is recognized as being plausible.

A particularly simple and reliable possibility of diagnosis, at the lowest possible computing expenditure, advantageously comes about if the battery voltage, after the activation of the coolant pump, is compared to a specified threshold value, and a malfunction is detected if the battery voltage falls below the specified threshold value.

### BRIEF DESCRIPTION OF THE DRAWINGS

FIG. 1 shows a schematic view of a drive unit having coolant circulation.

FIG. 2 shows a functional diagram for explaining the device according to the present invention and the method according to the present invention.

FIG. 3 shows a flow chart for an exemplary sequence of the method according to the present invention.

### DETAILED DESCRIPTION

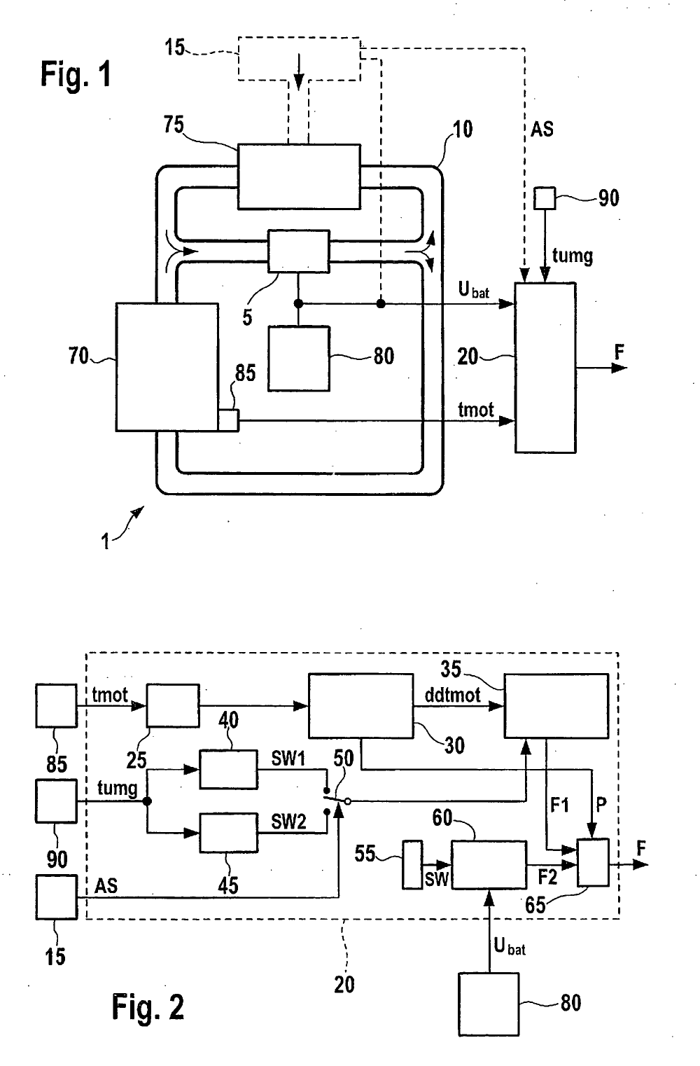

In FIG. 1, the numeral 1 designates a drive unit that includes an engine 70, for example, an Otto engine or a Diesel engine or an electric motor or an alternative drive. In the following, we assume, for instance, that the drive unit is developed as an internal combustion engine having an Otto engine or a Diesel engine. The drive, that is, the type of engine, is not relevant for the present invention. Internal combustion engine 1 also includes a closed coolant circulation 10, known to one skilled in the art, in which a coolant, such as water, is pumped through engine 70 and a radiator 75, using a coolant pump 5. Radiator 75 may be developed as an air coolant cooler, in this context. The cooling air is then conveyed through radiator 75 by the head wind, in the case of a vehicle driven by internal combustion engine 1, or optionally by a fan or additional fan 15. Protective means against corrosion and freezing may also be added to the coolant. Radiator 75 may also be designated as being a cooling element. Coolant pump 5 is supplied with voltage via a battery 80, such as a vehicle battery, same as the optionally present fan 15, as shown by dashed lines in FIG. 1. The battery voltage U_{bat} is also supplied, in this instance, to a device 20 according to the present invention, which is developed as an engine control or may be integrated into an engine control of internal combustion engine 1. Device 20 is used, in this instance, for operating internal combustion engine 1, and, to be specific, at least within the scope of carrying out a diagnosis of the functioning of coolant pump 5. In addition, and not essential to the present invention, device 20 may optionally avail itself of additional engine control functions for operating internal combustion engine 1, for instance, the activation of a throttle valve, fuel injectors and/or ignition depending on the design of engine 70 as an Otto engine or a Diesel engine. However, these functions are not important to the description of the present invention, and are therefore not discussed further below. Device 20 is described only with regard to the diagnosis of the functioning of coolant pump 5. Within the range of engine 70, there is a temperature sensor 85 which records engine temperature tmot and routes it to device 20. An ambient temperature sensor 90 is also provided, which records an ambient temperature tumg of internal combustion engine 1, and passes it on to device 20. In addition, fan 15 supplies an activation signal to device 20 which states whether fan 15 is active, that is, switched on or inactive, that is, switched off. Finally, device 20 emits a signal F which indicates whether coolant pump 5 is faulty or not.

The method according to the present invention and device 20 according to the present invention will now be explained in greater detail in their way of functioning, with the aid of FIG. 2. FIG. 2 represents a functioning diagram of device 20, in this context. Device 20 includes a low-pass filter 25 to which engine temperature sensor 85 supplies a continuous engine temperature signal tmot. This is subject to interference influences and noise influences, as a rule, and, under certain circumstances, the later evaluation will include negatively impairing signal fluctuations. The influences named are at least partially eliminated with the aid of low-pass filter 25, for which one has to select a suitable time constant for low-pass filter 25. This may be suitably applied on a test stand, for instance. Before the low-pass filtering, there is also a quantization of engine temperature signal tmot, with the result that, at the input of low-pass filter 25, only temperature changes are detectable that are greater than a minimum threshold value. What one would like to have is as rapid a reaction in response to changes in the engine temperature signal in the output of low-pass filter 25, for which the time constant should be selected as small as possible. However, as large a time constant as possible of low-pass filter 25 is required for the elimination of the above-mentioned interference influences and noise influences and the undesired signal fluctuations. Therefore, the time constant of low-pass filter 25 should be applied in the sense of a compromise between a possibly rapid reaction at the output of low-pass filter 25, on the one hand, and as great as possible a suppression of interference signals and/or noise signals, as well as undesired signal fluctuations, on the other hand.

The engine temperature signal, thus low-pass filtered, is supplied to a computing unit 30 which, for one, submits the supplied low-pass filtered engine temperature signal to a plausibility check, in a manner known to one skilled in the art, and secondly, also in a manner known to one skilled in the art, forms the second derivative with respect to time of the low-pass filtered engine temperature signal, using, for example, at least three successive sampling values of the low-pass filtered engine temperature signal. For the plausibility check of the low-pass filtered engine temperature signal it may, for instance, be provided that computing unit 30 compare the supplied low-pass filtered engine temperature signal, in a manner not shown, to an engine temperature signal modeled from operating variables of internal combustion engine 1, and recognize the low-pass filtered engine temperature signal as being plausible if it differs from the modulated engine temperature signal by not more than a specified tolerance value, in absolute value, and otherwise recognizes the low-pass filtered engine temperature signal as not being plausible. The result of the plausibility check is supplied by computing unit 30 to a logic element 65 in the form of a plausibility signal P, plausibility signal P being set in the case of a low-pass filtered engine temperature signal that is recognized as being plausible, and reset otherwise. The computed second derivative with respect to time of the low-pass filtered engine temperature signal is designated in FIG. 2 as ddtmot, and is supplied to a first comparator unit 35. Continuous signal with respect to time tumg of ambient temperature sensor 90 is supplied to a first characteristics curve 40 and to a second characteristics curve 45 of device 20. Furthermore, a controlled switch 50 is provided which, depending on the switch setting, connects either the output of first characteristics curve 40 or the output of second characteristics curve 45 to a second input of comparator unit 35.

The output of first characteristics curve 40 is a first specified threshold value SW1, and output of second characteristics curve 45 is a second specified threshold value SW2. Controlled switch 50 is activated by signal AS of optionally present fan 15 with respect to its switch setting. In this context, if fan 15 is inactive, that is, activating signal AS of fan 15 has been reset, switch 50 is activated in such a way that the output of first characteristics curve 40 is connected to first comparator unit 35, and thus the first specified threshold value SW1 is supplied to first comparator unit 35. In the other case, that is, in response to an activated fan 15, controlled switch 50 is controlled by activating signal AS, that is then set, to connect the output of second characteristics curve 45 to first comparator unit 35, so that second specified threshold value SW2 is supplied to first comparator unit 35. If there is no fan 15 present, this is equivalent to a non-activated fan, and, with that, to a reset activating signal AS, so that in this case only first characteristics curve 40 is required, whose output using first specified threshold value SW1 is then connected permanently to comparator unit 35.

First characteristics curve 40 and second characteristics curve 45 may, for instance, be suitably applied on a test stand, a lower cooling off of engine 70 during after-running of internal combustion engine 1 being associated with an increasing ambient temperature tumg at uniform pump performance of coolant pump 5, and consequently, threshold values SW1 and SW2 are specified to be lower than in the case of a lower ambient temperature tumg, and thus a greater cooling off effect on the engine temperature during after-running of internal combustion engine 1. In response to a switched-on fan 15, and thus a set activating signal AS, the cooling effect on engine 70 is greater than when fan 15 is switched off, and thus an inactive fan 15 and a reset activating signal AS. For this reason, first characteristics curve 40 is applied differently from second characteristics curve 45 at same ambient temperature tumg, and at same ambient temperature tumg, first specified threshold value SW1 for inactive fan 15 being applied larger than second specified threshold value SW2 for active fan 15.

The two threshold values SW1, SW2 are specified, in this instance, as a function of ambient temperature tumg in such a way that they represent a limiting value for an active or an inactive fan 15, respectively, and up until the reaching of which value, the second derivative with respect to time of the low-pass filtered engine temperature signal is characteristic of a fault-free functioning of coolant pump 5, and the exceeding of the respectively specified threshold value SW1, SW2 by the second derivative with respect to time of low-pass filtered engine temperature signal ddtmot is characteristic of a malfunction of coolant pump 5. Consequently, respectively specified threshold value SW1, SW2 represents a boundary value for the second derivative with respect to time of the low-pass filtered engine temperature signal ddtmot, at the exceeding of which a malfunction of coolant pump 5 is detected. In first comparator unit 35, second derivative with respect to time of low-pass filtered engine temperature signal ddtmot is compared to respectively specified threshold value SW1, SW2 that is respectively supplied depending on the switch setting of switch 50, in case of the exceeding of the corresponding threshold value, a set fault signal F1, and otherwise a reset fault signal F1 being transmitted to logic element 65. In this context, logic element 65 is only able to emit a set fault signal F at its output if the supplied plausibility signal P is set, that is, if the low-pass filtered engine temperature signal was recognized as being plausible. Otherwise, logic element 65 is reset permanently at its output F by reset plausibility signal P. When plausibility signal P is set, output F is set for the indication of a malfunction of coolant pump 5 only if fault signal F1 is also set at its input, otherwise fault signal F is reset, and no malfunction of coolant pump 5 is detected.

In addition or alternatively to elements 25, 30, 35, 40, 45, 50 of device 20, described up to this point, device 20 may include a diagnostic device that makes possible the diagnosis of a malfunction of coolant pump 5 with the aid of an evaluation of battery voltage U_{bat}. For this purpose, device 20 according to FIG. 2 includes a second comparator unit 60, which has supplied to it battery voltage U_{bat} by battery 80 and a threshold value SW by a threshold memory 55. For this purpose, threshold value SW may be applied in a suitable manner on a test stand, for instance. Comparator unit 60 emits a second fault signal F2, that is reset, if coolant pump 5 is not activated or if battery voltage U_{bat} is less than or equal to specified threshold value SW. If coolant pump 5 is activated, and if battery voltage U_{bat} exceeds specified threshold value SW, second comparator unit 60 emits a set signal as a second fault signal F2. Threshold value SW is suitably applied on the test stand, in this instance, in such a way that a voltage dip of battery voltage U_{bat} expected in the case of a coolant pump 5 that is in working order is less than or equal to specified threshold value SW, whereas too low a voltage drop based on a faulty functioning of coolant pump 5 leads to a battery voltage U_{bat} above specified threshold value SW. Second fault signal F2 is emitted as fault signal F in the case in which the malfunction of coolant pump 5 takes place only in the light of the described diagnosis of battery voltage U_{bat}. For the case in which the diagnosis of a malfunction of coolant pump 5 is based both on the described evaluation of battery voltage U_{bat} and on the evaluation of the second derivative with respect to time of low-pass filtered engine temperature signal ddtmot, second fault signal F2 is supplied to logic element 65 together with first fault signal F1 and plausibility signal P, as shown in FIG. 2. This element may then be designed as an AND gate or as an OR gate. In the case of the design as an AND gate, a malfunction of coolant pump 5, in this instance, is detected only, and fault signal F is set only if both first fault signal F1 and second fault signal F2 are set in response to simultaneously set plausibility signal P, that is, both the evaluation of the battery voltage and the evaluation of the second derivative with respect to time of low-pass filtered engine temperature signal ddtmot let one conclude that there is a malfunction of coolant pump 5.

In the case of the design of logic element 65 as an OR gate, fault signal F is set at the output of device 20 if either first fault signal F1 is set at simultaneously set plausibility signal P, independently of the state of second fault signal F2, or if second fault signal F2 is set independently of the state of plausibility signal P and first fault signal F1. In this case, the malfunction of coolant pump 5 is detected if at least one of the two described evaluations of the battery voltage and of the second derivative with respect to time of the low-pass filtered engine temperature signal ddtmot let one conclude that there is a malfunction of coolant pump 5. In the case of the design of logic element 65 as an OR gate, based on the above-described, the representation according to FIG. 2 should be changed to the extent that first fault signal F1 and plausibility signal P are first supplied to an AND gate, whose output is then supplied, together with second fault signal F2 as the only input variables to logic element 65 in the form of an OR gate, at whose output fault signal F is then present.

Fault signal F may be drawn upon for incrementing a fault counter or directly for indicating a malfunction of coolant pump 5. In addition, or alternatively, as a function of a set fault signal F, an emergency operation function of internal combustion engine 1 is able to be induced as a fault reaction measure, as a last resort shutting down internal combustion engine 1, in order to prevent damage to internal combustion engine 1 caused by too high an engine temperature.

By the device according to the present invention and the method according to the present invention, during after-running of internal combustion engine 1, the behavior of the engine temperature is monitored, and is investigated with the aid of the respectively specified threshold value SW1, SW2 for a break in the temperature curve after the switching on of a fault-free functioning coolant pump 5. This break is detected, in the manner described, by comparison of the second derivative with respect to time of the low-pass filtered engine temperature signal to the respective threshold value SW1, SW2. This break is detectable, in this context, in many different ambient situations of internal combustion engine 1, and in various external and internal conditions of internal combustion engine 1, such as the driving cycle, the ambient temperature, the parking area of the internal combustion engine and the configuration of fan 15, and independently of these conditions. The corresponding applies for the diagnosis described, based on battery voltage U_{bat}. The diagnosis described by the evaluation of the second derivative with respect to time of the low-pass filtered engine temperature signal or the battery voltage may be implemented onboard or in a garage, for instance, using a garage tester. The described low-pass filtering of engine temperature signal tmot is not required, in principle, for the method of functioning of the present invention, but it enhances the reliability of the result of the diagnosis.

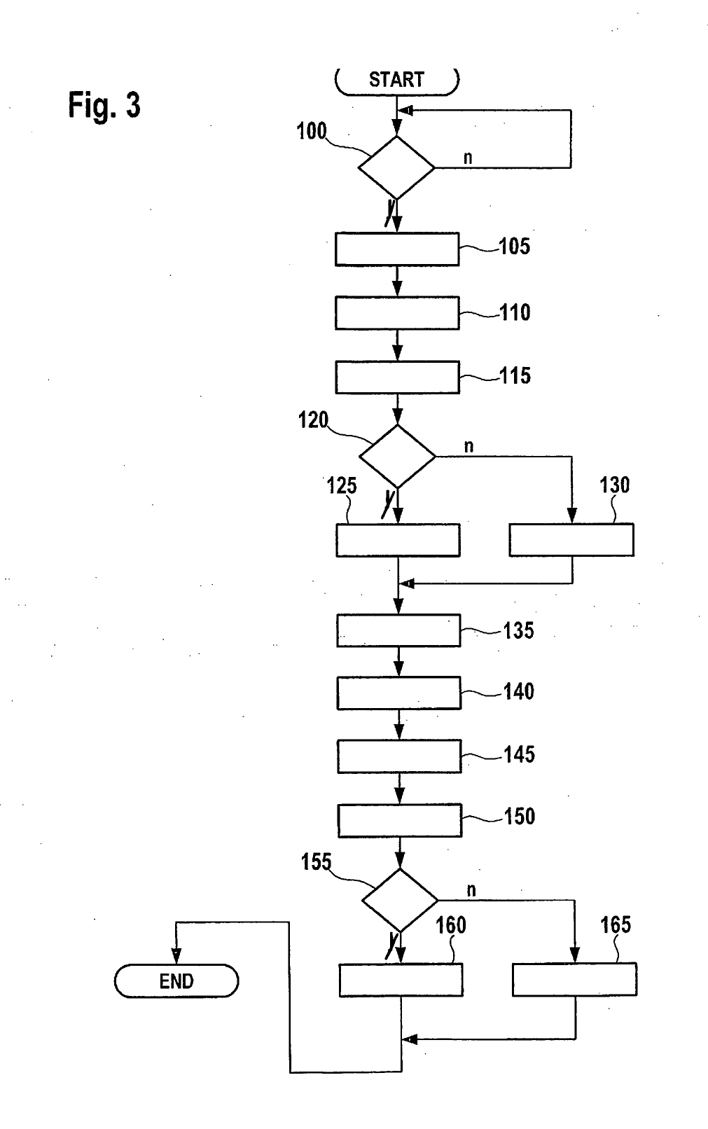

An exemplary sequence of the method according to the present invention is shown below, with the aid of the flow chart in FIG. 3. After the start of the program, the engine control checks, at program point 100, whether the ignition, or rather engine 70 has been shut down. If this is the case, branching to a program point 105 occurs; otherwise, it is returned to program point 100.

At program point 105, the engine control activates coolant pump 5, during after-running of internal combustion engine 1, after shutting down engine 70. The program then branches to a program point 110. At program point 110, engine temperature signal tmot is filtered in low-pass filter 25. The low-pass filtered engine temperature signal is sampled in computing unit 30 at an applicable time t1, and the sampled value is stored. An applicable time later, the low-pass filtered engine temperature signal is sampled again in computing unit 30, and the sampled value is stored. The second derivative with respect to time is formed from the two sampled values for the low-pass filtered engine temperature signal. An applicable time later, this first derivative with respect to time of the low-pass filtered engine temperature signal is computed once more, in a corresponding manner. From these two first derivatives with respect to time, the second derivative with respect to time of the low-pass filtered engine temperature signal is then formed. In addition, at program point 110, battery voltage U_{bat} is recorded by second comparator unit 60. Branching to a program point 115 then takes place.

At program point 115, the ambient temperature tumg is recorded using ambient temperature sensor 90. Branching to a program point 120 then takes place.

At program point 120 it is checked with the aid of activating signal AS whether fan 15 is activated. If this is the case, branching to a program point 125 takes place; otherwise, branching to a program point 130 occurs.

At program point 125, controlled switch 50 is activated for the connection of the output of second characteristics line 45 to first comparator unit 35. Branching to a program point 135 then takes place.

At program point 130, controlled switch 50 is activated for the connection of the output of first characteristics line 40 to first comparator unit 35. The program subsequently branches to program point 135.

At program point 135, first comparator unit 35 compares the second derivative with respect to time of low-pass filtered engine temperature signal ddtmot to the specified threshold value supplied, depending on the switch position of switch 50, and forms first fault signal F1, depending on the result of the comparison. In addition, at program point 135, second comparator unit 60 compares battery voltage U_{bat} to specified threshold value SW, and forms second fault signal F2, as a function of the result of the comparison, in the manner described. Branching to a program point 140 then takes place.

At program point 140, computation unit 30 ascertains plausibility signal P as a function of the plausibility testing described, of the low-pass filtered engine temperature signal. Branching to a program point 145 then takes place.

At program point 145, plausibility signal P is AND-linked to first fault signal F1. Branching to a program point 150 then takes place.

At program point 150, the result of the AND-linking is OR-linked to second fault signal F2 and the linking result is given off as fault signal F. At program point 155 it is then checked whether fault signal F is set. If this is the case, branching to a program point 160 takes place; otherwise, branching to a program point 165 occurs.

At program point 160, a fault is detected in coolant pump 5, and indicated, or rather, a fault reaction measure is initiated in the manner described. At program point 165 a fault-free operation of coolant pump 5 is detected. The program is exited both after program point 160 and after program point 165.

For the evaluation of battery voltage U_{bat} it may be provided that one should make the formation of specified threshold value SW dependent on whether fan 15 is activated, that is, switched on, or not activated, that is, switched off. In the case of a switched-on fan 15, specified threshold value SW is applied smaller than for a switched-off fan 15, since in the case of a switched-on fan 15 and a switched-on coolant pump, during after-running of internal combustion engine 1, a greater voltage dip in battery voltage U_{bat} is to be expected than in the case of a switched-on coolant pump 5 and a switched-off fan 15.

Usually, engine temperature tmot rises more or less greatly shortly after shutting off the ignition or engine 70, as a function of the previous driving cycle. Depending on the effect of the cooling after the activation of coolant pump 5 during after-running of internal combustion engine 1 and possibly of fan 15, this temperature increase is damped, by the activation of the fan in addition to the activation of coolant pump 5, more than with a deactivated fan 15 and the sole operation of coolant pump 5.

Instead of using the engine temperature for the evaluation of the second derivative with respect to time for the diagnosis of a malfunction of the coolant pump, any other variable influenced by the operation of the coolant pump of internal combustion engine 1 may also be used, in the manner described, for the diagnosis of a malfunction of the coolant pump. Suitable variables are, in particular, the engine oil temperature, the coolant temperature at any particular place in coolant circulation 10, or the temperature of the engine block itself, which are in each case able to be recorded using a suitable temperature sensor, or which are able to be modeled, in a manner known to one skilled in the art, from other operating variables of internal combustion engine 1. In this context, the second derivative with respect to time may also be formed from the modeled, instead of the measured, variable of internal combustion engine 1, that is influenced by the operation of the coolant pump. It is also true that the plausibility check of this variable is only optional, and not required, in principle, for the manner of functioning of the present invention. However, owing to the checking for plausibility, the diagnostic result becomes more reliable.

The curve over time of the variable of the internal combustion engine influenced by the operation of the coolant pump may also be diagnosed by the first derivative with respect to time of this variable, instead of the second derivative with respect to time, for instance, by comparing the first derivative with respect to time, and thus the slope of the variable of the internal combustion engine, that is influenced by the operation of the coolant pump, to a suitably applied threshold value. In the case of a defective coolant pump, the slope, for instance, of the engine temperature during after-running of the internal combustion engine, is greater than for a coolant pump that is functioning in a fault-free manner. Consequently, by having a suitably selected threshold value for the slope, one is also able to distinguish a fault-free operation of the coolant pump from a faulty one.

All the elements 25, 30, 35, 40, 45, 50, 55, 60, 65 of device 20, described in FIG. 2, represent diagnostic means, the detection of the malfunction being implemented, in the last analysis, by logic unit 65, using emitted fault signal F.

What is claimed is:

1. A method for operating a drive unit having a coolant pump in a coolant circulation of an engine, the method comprising:
diagnosing a function of the coolant pump in an after-running of the drive unit; and
detecting a malfunction of the coolant pump as a function of at least one of a variable characterizing a battery voltage of the drive unit and a variable characterizing a curve over time of a variable that is influenced by an operation of the coolant pump, in the after-running of the drive unit.

2. The method according to claim 1, further comprising selecting a variable characterizing an engine temperature of the drive unit as the variable influenced by the operation of the coolant pump.

3. The method according to claim 2, further comprising selecting the second derivative with respect to time of the variable influenced by the operation of the coolant pump as the variable characterizing the curve over time of the variable influenced by the operation of the coolant pump.

4. The method according to claim 3, further comprising comparing the second derivative with respect to time of the engine temperature in the after-running of the drive unit to a specified threshold value, a malfunction of the coolant pump being detected if the second derivative with respect to time exceeds the specified threshold value.

5. The method according to claim 4, wherein the threshold value is specified as a function of an ambient temperature of the drive unit.

6. The method according to claim 4, wherein the threshold value is specified as a function of an operation of a fan.

7. The method according to claim 6, wherein the specified threshold value is selected to be smaller in the case of an activated fan than in the case of an inactive fan.

8. The method according to claim 1, wherein a malfunction of the coolant pump is detected only if the variable influenced by the operation of the coolant pump is recognized as being plausible.

9. The method according to claim 1, further comprising comparing the battery voltage after an activation of the coolant pump to a specified threshold value, a malfunction of the coolant pump being recognized if the battery voltage exceeds the specified threshold value.

10. A device for operating a drive unit having a coolant pump in a coolant circulation of an engine, comprising:
means for diagnosing a function of the coolant pump in an after-running of the drive unit; and
means for detecting a malfunction of the coolant pump as a function of at least one of a variable characterizing a battery voltage of the drive unit and a variable characterizing a curve over time of a variable influenced by an operation of the coolant pump in the after-running of the drive unit.
